(19) United States
(12) Patent Application Publication
(10) Pub. No.: US 2007/0018812 A1
(43) Pub. Date: Jan. 25, 2007

(54) SEPARATION ALERT SYSTEM

(76) Inventors: Steven R. Allen, Crowley, TX (US); Rebecca E. Allen, Crowley, TX (US)

Correspondence Address: Michael A. O'Neil;Michael A. O'Neil, P.C., Suite 820, 5949 Sherry Lane, Dallas, TX, 75225, US

(21) Appl. No.: 11/536,321

(22) Filed: Sep. 28, 2006

Related U.S. Application Data
(63) Continuation-in-part of application No. 10/909,626, filed on Aug. 2, 2004.
(60) Provisional application No. 60/492,533, filed on Aug. 5, 2003.

(51) Int. Cl. G08B 1/08; G08B 23/00

(52) U.S. Cl. 340/539.13; 340/573.4; 340/539.15

(57) ABSTRACT

A separation alert system includes a first component securable to a child, an elderly or disabled person, or an animal. A second component is securable to a person having responsibility for the child, the elderly or disabled person, or the animal. The second component includes an alarm which is activated whenever the second component is separated from the first component by more than a predetermined distance.

### CROSS-REFERENCE TO RELATED APPLICATIONS

This application is continuation-in-part application of application Ser. No. 10/909,626 filed Aug. 2, 2004, currently pending, the entire contents of which are incorporated herein by reference; which claims priority of application Ser. No. 60/492,533 filed Aug. 5, 2003, the entire contents of which are incorporated herein by reference.

### TECHNICAL FIELD

This invention relates generally to the protection of children, elderly and disabled persons, and animals, and more particularly to a system for triggering an alarm whenever a person providing supervision for children, elderly or disabled persons, or animals is separated by a more than a predetermined distance from an individual child, elderly or disabled person, or animal being supervised.

### BACKGROUND AND SUMMARY OF THE INVENTION

As is well known, children are frequently injured or killed as a result of being left in vehicles while the responsible adult runs an errand, etc. A related but usually less tragic problem involves the separation of children from the responsible person during shopping or recreational activities, either because the child is hiding or because the child is simply lost. Similar problems arise when elderly or disabled persons wander away from a supervised location. Yet another related problem is the unintended separation of animals from their owners during hunting and other activities.

The present invention addresses the foregoing and similar problems which have long since characterized the prior art. In accordance with the broader aspects of the invention, an alarm is triggered whenever a child, an elderly or disabled person, or an animal is separated from the responsible person by more than a predetermined distance. For example, if a child is left in a vehicle when the responsible person leaves the vehicle to run an errand, etc. an alarm is triggered. If a child is separated from the responsible person by more than a predetermined distance during shopping or recreational activities, an alarm is triggered. If an elderly or disabled person wanders away from a supervised area, an alarm is triggered. If an animal wanders away from its master during hunting or other activities, an alarm is triggered.

In accordance with more specific aspects of the invention, a first component of the system of the present invention is secured to a child, an elderly or disabled person, a pet or other animal, etc. In the case of an infant, the first component may be secured to a car seat or similar device in which the child is secured. In the case of older children and elderly or disabled persons, the first component is secured to a clothing item worn by the individual. In the case of a pet or other animal, the first component is secured to a collar or harness worn by the animal.

A second component of the system of the present invention is secured to the person, typically an adult, that is responsible for the safety of the child, the elderly or disabled person, or the animal to which the first component is secured. Whenever the first and second components of the system are separated by more than a predetermined distance, the second component of the system is activated to generate an alarm which may be audible, visible, or both. The alarm may also have a vibration mode similar to that employed in many mobile or wireless phones. Preferably, the amount of separation between the first and second components of the system which is sufficient to activate the alarm is adjustable thereby preventing actuation of the alarm except in case of a genuine emergency.

In accordance with another aspect of the invention, a plurality of first components of the system is provided. Each of the first components of the system is tuned to a different frequency. An individual second component of the system is adapted for actuation whenever it is separated by more than a predetermined distance from any of the first components of the system. In this manner a single responsible adult is able to provide supervision for a plurality of children, a plurality of elderly or disabled persons, a plurality of pets or other animals, etc.

### BRIEF DESCRIPTION OF THE DRAWINGS

A more complete understanding of the present invention may be had by reference to the following Detailed Description when taken in connection with the accompanying Drawings, wherein:

FIG. 1 is a diagrammatic illustration of a first utilization of the invention;

FIG. 2 is a diagrammatic illustration of a second utilization of the invention;

FIG. 3 is a diagrammatic illustration of a third utilization of the invention;

FIG. 4 is a diagrammatic illustration of a fourth utilization of the invention;

FIG. 5 is a diagrammatic illustration of a fifth utilization of the invention;

FIG. 6 is a block circuit diagram of one embodiment of a an individual second component of the invention;

FIG. 7 is a block circuit diagram of a second embodiment of an individual second component of the invention; and

FIG. 8 is a block circuit diagram of an individual first component of the invention.

### DETAILED DESCRIPTION

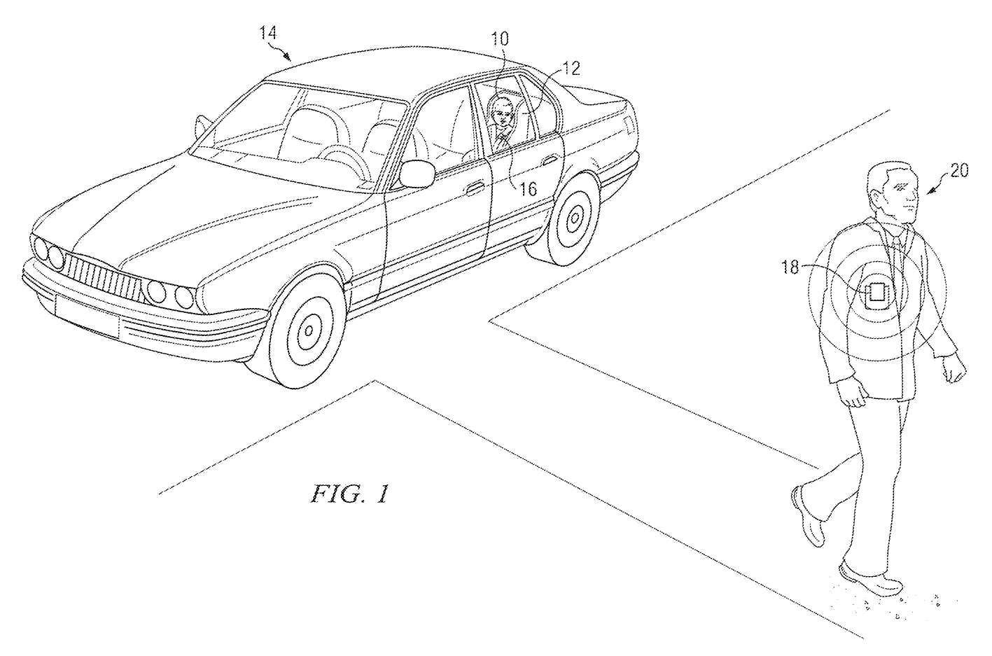

Referring now to the drawings, and particularly to FIG. 1 thereof, there is shown a first utilization of the separation alert system of the present invention. An infant 10 is secured in a car seat 12 which is in turn secured in an automobile 14. A first component 16 of the system of the present invention is shown secured to part of the car seat 12, it being understood that the component 16 can also be secured to the clothing of the infant 12 or to the structure of the automobile 14. A second component 18 of the system of the present invention is secured to the clothing of an adult 20 that is responsible for the safety of the infant 10.

Assume that the adult 20 leaves the infant 10 in the automobile 14 while running an errand or engaging in some other activity. As soon as the second component 18 of the system of the present invention is separated from the first component 16 thereof by more than a predetermined distance, the second component 18 is activated to produce an alarm thereby warning the adult 20 not to leave the infant 10. The alarm generated by the second component 18 may be audible, visible, or both. The alarm may also have a vibration mode. Preferably, the amount of separation between the first component 16 and the second component 18 of the system of the present invention which is necessary to activate the alarm is adjustable thereby allowing the adult 20 to move a short distance away from the infant 10 without triggering the alarm.

As will be appreciated by those skilled in the art, the present invention is capable of operating in a variety of modalities. By way of example only, the second component of the system of the present invention, that is, the component associated with a responsible adult, emits an inquiry signal at periodic intervals such as once every two seconds. If the first component of the system of the present invention, that is, the component which is secured to a child, an elderly or disabled person, or a pet or other animal requiring supervision is within range of the inquiry signal emitted by the first component, the first component emits a response signal. If the second component of the system receives a response signal from a first component, no alarm is triggered. However, should the second component of the system fail to receive a timely response signal from any first component of the system associated therewith, an alarm is triggered.

Regulation of the separation distance between the first and second components that triggers an alarm can be accomplished by regulating the intensity at which the response signal of the first component is emitted. By reducing the intensity of the response signal, the alarm is triggered at a closer distance, and vice versa.

In accordance with a second operational modality of the present invention, the first component of the separation alert system emits a response signal on a continuous basis. The second component of the separation alert system is continuously actuated to receive the response signal from the first component thereof. Whenever the second component of the system does not receive the response signal from the first component for a predetermined period of time, an alarm is triggered. The degree of separation between the first component of the system and the second component thereof that is necessary to trigger an alarm can be varied by varying the intensity of the response signal emitted by the first component.

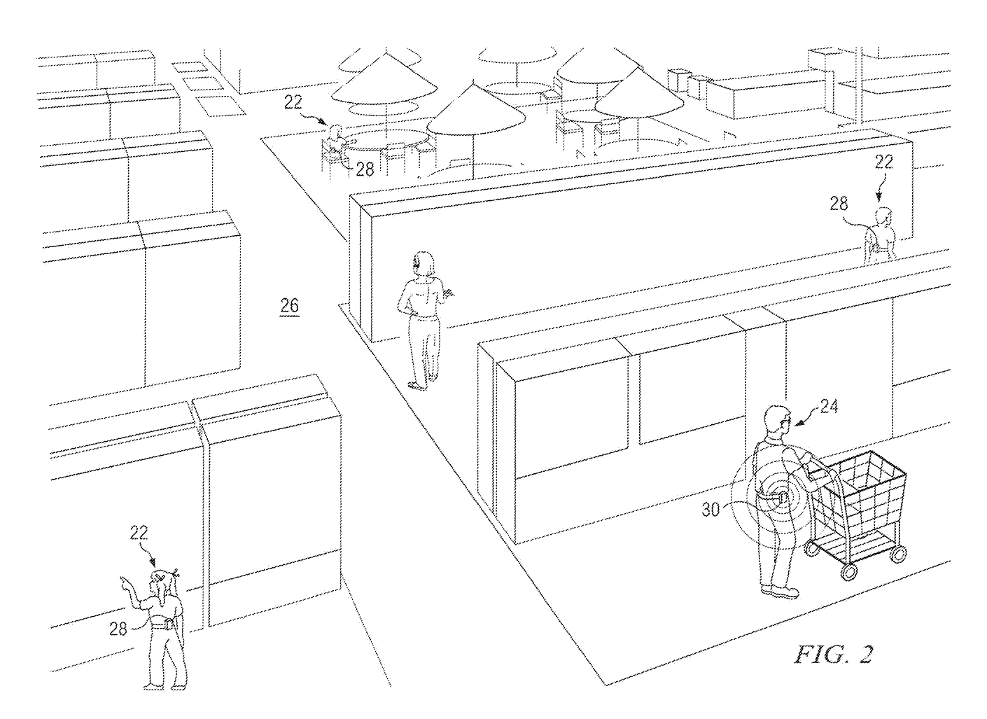

Referring to FIG. 2, a second utilization of the separation alert system of the present invention is diagrammatically illustrated. Several older children 22 and an adult 24 having responsibility for the children 22 visit a shopping facility 26, etc. A first component 28 of the system of the present invention is secured to a clothing item worn by each child 22, for example, a belt. A second component 30 of the system of the present invention is secured to a clothing item worn by the adult 24. Whenever any of the first components 28 and the second component 30 of the system of the present invention are separated by more than a predetermined distance, the second component 30 is activated to generate an alarm which is indicative of too much separation between one of the children 22 and the responsible adult 24. As will be readily understood, such separation can occur because the child is hiding, or because the child has become distracted during play, or because the child is simply lost, etc.

The alarm which is activated when the second component 30 of the present invention is separated by more than a predetermined distance from any of the first components 28 thereof may be audible, visible, vibrational, or any combination thereof. The alarm may include multiple, visible components including a signal light or LED, multiple signal lights or LED's, or a liquid crystal display (LCD) which shows the name associated with the particular first component 28 of the invention that triggered the alarm. The audible component of the alarm may comprise a plurality of unique alarm tones each associated with an individual first component 28 of the invention. Similarly, the vibratory component of the alarm may operate at different vibrational frequencies or sequences depending upon which of the first components 28 triggered the alarm. Preferably the amount of separation between the components 28 and 30 that is necessary to activate the alarm is adjustable so that the adult 24 can move a predetermined distance away from the child 22 without activating the alarm.

It is also preferable that the second component 30 of the system of the present invention is capable of identifying which of the several first components 28 thereof triggered the alarm. This is accomplished by assigning a different frequency to each of the first components 28. The second component 30 generates inquiry signals which are sent to all of the first components 28 at periodic intervals, for example, every two seconds. When an individual first component 28 receives an inquiry signal, it generates a response signal at its assigned frequency. The second component 30 receives and responds to response signals at all of the frequencies assigned to the first components 28. If the second component 30 fails to receive a response signal from any of the first components 28, the second component 30 generates an alarm which is identified with the first component 28 from which a response signal was not received.

FIG. 2 illustrates the invention utilized at a shopping center. However, the invention is equally adapted for utilization at daycare facilities, schools, amusement parks, theme parks, theaters, etc.

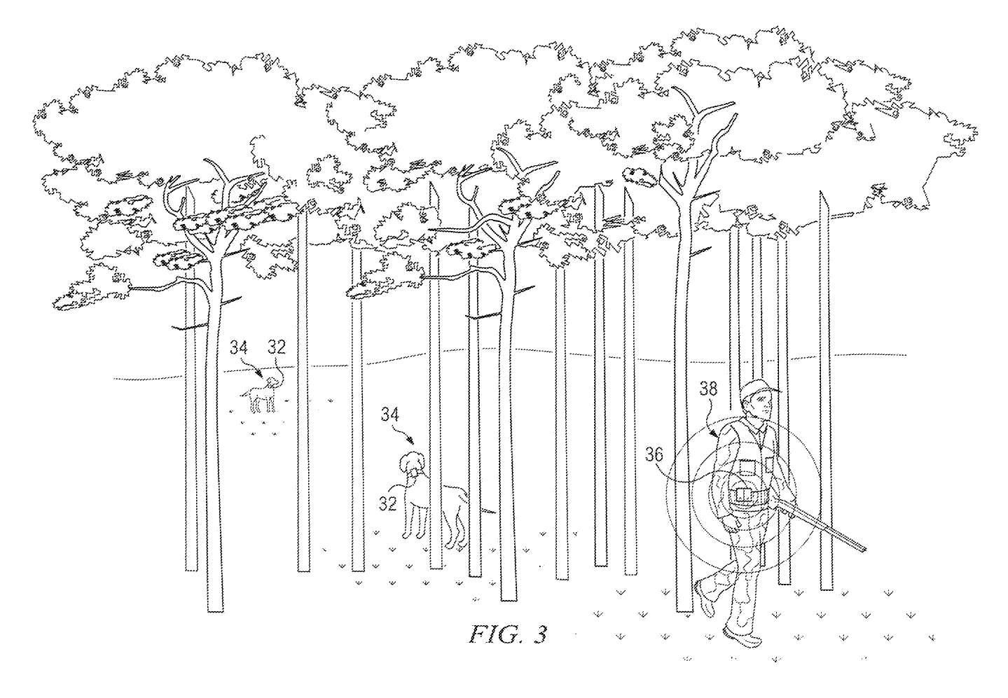

A third utilization of the separation alert system of the present invention is illustrated in FIG. 3. A first component 32 of the system of the present invention is secured to each of a plurality of animals 34 typically by attachment to a collar, harness, etc. worn by the animal. The second component 36 of the system of the present invention is secured to a clothing item worn by the master 38 of the animals 34. As is clearly shown in FIG. 3, the second component 36 is segregated into multiple sections each associated with one of the animals 34. In FIG. 3 the master 38 and the animals 34 are shown engaging in a hunting activity; however, it will be understood that the present invention is equally applicable to other activities involving the animals 34 and the master 38. For example, the invention can be utilized at dog kennels, etc.

Whenever a predetermined separation occurs between one of the first components 32 and the second component 36 of the system of the present invention, the second component 36 is activated to generate an alarm. The alarm may be either audible, visible, vibrational, or any combination thereof. Preferably, the amount of separation between the first components 32 and the second component 36 of the present invention which is necessary to activate the alarm is adjustable thereby allowing the animals 34 to have a certain amount of freedom of movement relative to the master 38 without triggering the alarm.

When the separation alert system of the present invention is used with multiple animals, the first component 32 of the system assigned to each animal 34 operates at a different frequency as compared to the first components 32 assigned to other animals 34. This allows the second component 36 of the system to identify which of the animals 34 has strayed in the manner described above.

Activation of the alarm comprising the second component 36 of the system of the present invention notifies the master 38 that one or more of the animals 34 has strayed too far away. This allows the master 38 to initiate an appropriate action to bring the animal 34 back into closer proximity before the animal 34 has wandered so far away that recovery is either difficult or impossible. For example, the master 38 may utilize a voice command, a whistle, an electronic collar, or the master 38 may simply begin searching for the animal 34 that has strayed.

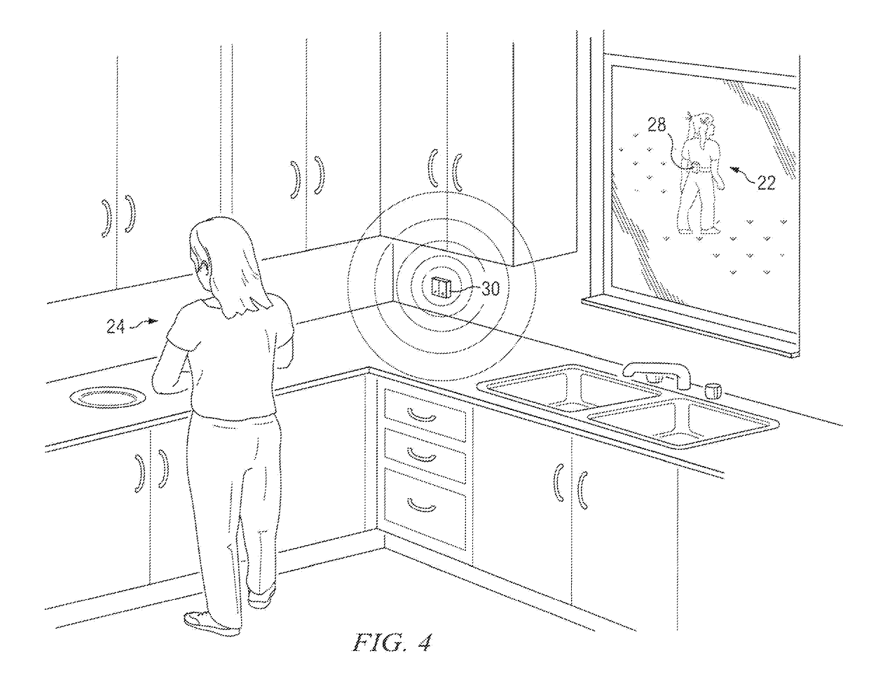

FIG. 4 illustrates a fourth utilization of the invention. The fourth utilization is similar in many respects to the second utilization thereof which is illustrated in FIG. 2 and described hereinabove in conjunction therewith. The component parts of the present invention are designated in FIG. 4 with the same reference numerals utilized in the description of the second utilization of the invention.

The fourth utilization of the invention is similar to the second utilization thereof in that one or more children 22 are each provided with a first component 28 of the present invention which is secured to the child 22 identified therewith by attachment to a clothing item, for example, a belt. The fourth utilization of the invention differs from the second utilization in that the second component 30 of the separation alert system of the present invention is not secured to a responsible adult 24, but is instead secured at a convenient location within a building, such as a home, in which the responsible adult 24 is working or otherwise engaged.

The second component 30 of the separation alert system is adapted to provide an audible, visual, vibrational, or combination signal sufficient to alert the responsible adult 24 even though the responsible adult 24 moves a significant distance away from the second component 30. In those circumstances in which multiple children 22 are being monitored simultaneously, the second component 30 of the present invention is adapted to generate a signal, either audible, visual, vibrational, or any combination thereof, which identifies the particular child 22 that has strayed too far for the response signal generated by the first component 28 to be recognized by the second component 30.

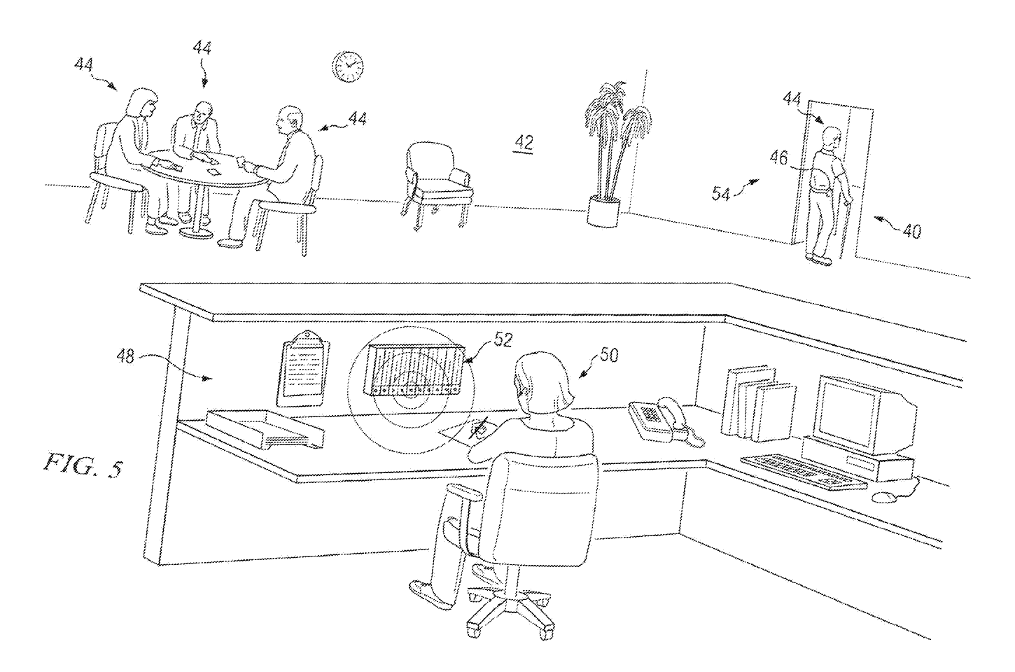

A fifth utilization of the invention is illustrated in FIG. 5. A nursing home, recreational center, or similar facility 40 includes a secure area 42. The secure area 42 is illustrated in FIG. 5 as comprising a room, however, the secure area 42 may comprise multiple rooms, an entire building, an indoor/outdoor facility, a facility located entirely outdoors, etc.

A plurality of elderly or disabled individuals 44 are temporarily confined to the secure area 42 in order to assure their safety, and to facilitate the provision of medical or other aid should circumstances warrant. Each of the individuals 44 is provided with a first component 46 comprising the present invention. Each first component 46 is secured to a clothing item worn by one of the individuals 44. Each first component 46 has a different response signal frequency assigned thereto.

The secure area 42 includes a workstation 48. One or more responsible adults 50 are constantly present at the workstation 48 in order to be available to provide assistance to the individuals 44 on an as needed basis. A second component 52 of the present invention is located at the workstation 48 for ready access by one or more responsible adults 50 located therein. The second component 52 receives response signals from all of the first components 46 which are secured to the individuals 44. As indicated at 54, one of the individuals 44 may attempt to leave the secure area 42. In such instances the second component 52 generates an alarm signal which is specifically identified with the particular individual 44 that has left the secure area 42.

Activation of the alarm comprising the second component 52 of the system of the present invention notifies the responsible adult 50 that one or more of the individuals 44 has strayed out of the secure area 42. This allows the responsible adult 50 to initiate an appropriate action to return the individual 44 back into the secure area 42.

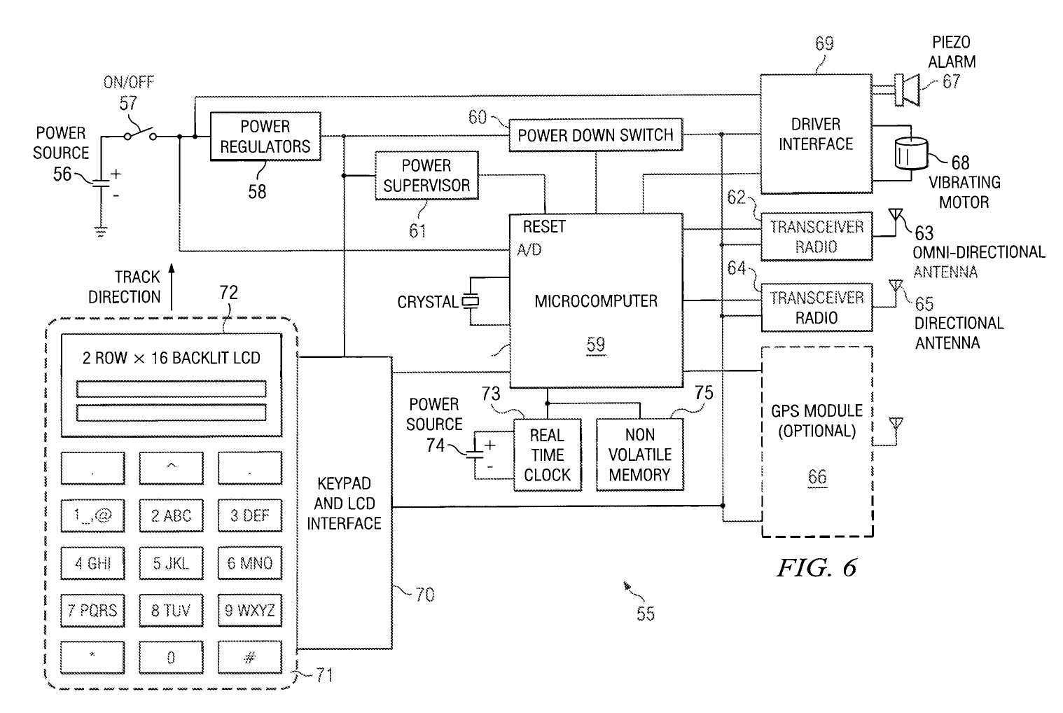

With reference to FIG. 6, one embodiment of the invention includes a second component 55 capable of emitting and receiving a signal, which includes a power system. The power system includes a power source 56 used to power the second component 55 and an on/off switch 57 necessary to turn the power to the second component 55 on and off. Common available batteries can be utilized for the power source 56. Additionally, backup batteries can be utilized in order to facilitate power to the second component 55 in the event of main battery failure. Depending on standby power requirements, the on/off switch may be substituted with a soft switch capable of being activated by keypad depression.

The power system of the second component 55 further includes at least one power regulator 58 for adjusting power in the power source 56 to suitable levels to control a microcomputer 59 and the other electronic components of the second component 55. At least one power down switch 60 of the power system is controlled by the microcomputer 59 to allow electronic components of the second component 55 to be shut down when not in use by the second component 55 for the purpose of conserving power in the power source 56. A power supervisor 61 of the power system will reset the microcomputer 59 in the event power deviates outside of specified limits.

The microcomputer 59 controls all electronic components of the second component 55. The microcomputer 59 monitors the power from the power source 56. For example, when a battery power source is utilized, the microcomputer 59 will monitor the battery voltage. In the event battery power becomes diminished to a specified level, the microcomputer 59 will cause the second component 55 to go into low battery mode. An alarm system or a LCD display of the second component 55 can be utilized so as to alert an user that the battery is low, in order to allow the user to change the battery, etc. Likewise, if a first component transmits to the second component 55 that its power source is diminished, the second component 55 can be utilized to alert the user of the second component 55. For example, a LCD or other display can be utilized so as to display a flashing low battery icon corresponding to the first component. Upon noticing the alarm or the flashing low battery icon, the user of the second component 55 will know to change the battery, etc.

The second component 55 also includes a means for emitting and receiving a signal. In the embodiment shown, a first transceiver radio 62 utilizing an omni-directional antenna 63 sends an inquiry signal to at least one first component, as further discussed heretofore. This signal can be sent intermittently or continuously, depending on the specific circumstances. If the first component is within the range of the inquiry signal, the first component emits a response signal. The omni-directional antenna 63 receives the response signal from the first component(s). If the second component 55 receives a response signal via the omni-directional antenna 63 from the first component, no alarm is sounded. However, should the second component 55 fail to receive a timely response signal from any first component, an alarm is sounded. Regulation of the separation distance between the second component 55 and first component that triggers an alarm can be accomplished by regulating the intensity at which the response signal of the first component is emitted. By reducing the intensity of the response signal, the alarm is triggered at a closer distance, and vice versa.

Additionally, the second component 55 preferably includes a means for tracking, by directional and positional location, a first component. In the embodiment shown, a second transceiver radio 64 utilizes a directional antenna 65 to monitor the signal(s) received by the omni-directional antenna 63 from the first component(s). A LCD or other display can be utilized to display an arrow or other icon which indicates the directional position of a first component, as interpreted from the signal received from the omni-directional antenna 63 and the directional antenna 65. The strength of the signal emitted by a first component can also be monitored by the directional antenna 65, thereby indicating the distance of a first component from the second component 55, a strong signal indicating closer proximity of a first component to the second component 55, and vice versa. The distance of a first component to or from the second component 55 can likewise be displayed on the second component utilizing a LCD or other display. In this manner, the user can track a first component.

An optional GPS module 66 can also be utilized by the second component 55 as an additional means to track a first component. The GPS module 66 identifies the longitude and latitude of the second component 55, and the second component 55 receives a signal of a first component transmitting its longitude and latitude to the second component 55. The second component 55 then employs this information to calculate the position of a first component in relation to the second component 55. A LCD or other display is then utilized to display this information to the user. In this manner, the user tracks a first component.

An alarm system including a piezo alarm 67 and a vibrating motor 68 is also included as part of the second component. In the embodiment shown, the piezo alarm 67 warns a user when a first component exceeds a specified range from the second component 55 as described heretofore. In addition to the piezo alarm 67, the vibrating motor 68 can also be utilized to warn a user that a first component has exceeded a specified range from the second component 55. The piezo alarm 67 and vibrating motor 68 can also be used to warn the user that the power source 56 is diminished, as discussed heretofore. A driver interface 69 works in conjunction with the microcomputer 59 to control the piezo alarm 67 and vibrating motor 68 accordingly.

A keypad and LCD interface 70 is included as part of the second component 55. The keypad 71 portion of the keypad and LCD interface 70 allows a user to input data or other information into the second component 55, and the LCD display 72 portion of the keypad and LCD interface 70 allows a user to view data or other information, such as the directional and positional location of a first component an identifier associated with a first component, a low battery indicator, or any other relevant data or information, as discussed in more detail heretofore. In the embodiment shown, the keypad 71 is similar to keypads utilized by various mobile or wireless telephones, utilizing numeric, alphanumeric, and symbolic inputs to allow a user to input data or other information into the second component 55. The keypad 71 also allows the user to scroll through various menus and data or information displayed on the LCD display 72. The keypad and LCD interface 70 is backlit and totally programmable by the microcomputer.

An additional feature of the embodiment shown is a real time clock 73. The real time clock can implement its own power source 74. Common available batteries can be utilized for the power source 74. Additionally, backup batteries can be utilized in order to facilitate power to the real time clock 73 in the event of main battery failure. Alternatively, the real time clock may be powered by the power source 56.

A non volatile memory 75 is included, allowing data or other information to be saved by the second component 55. This saved data or other information can likewise be recalled from the non volatile memory 75 by the user.

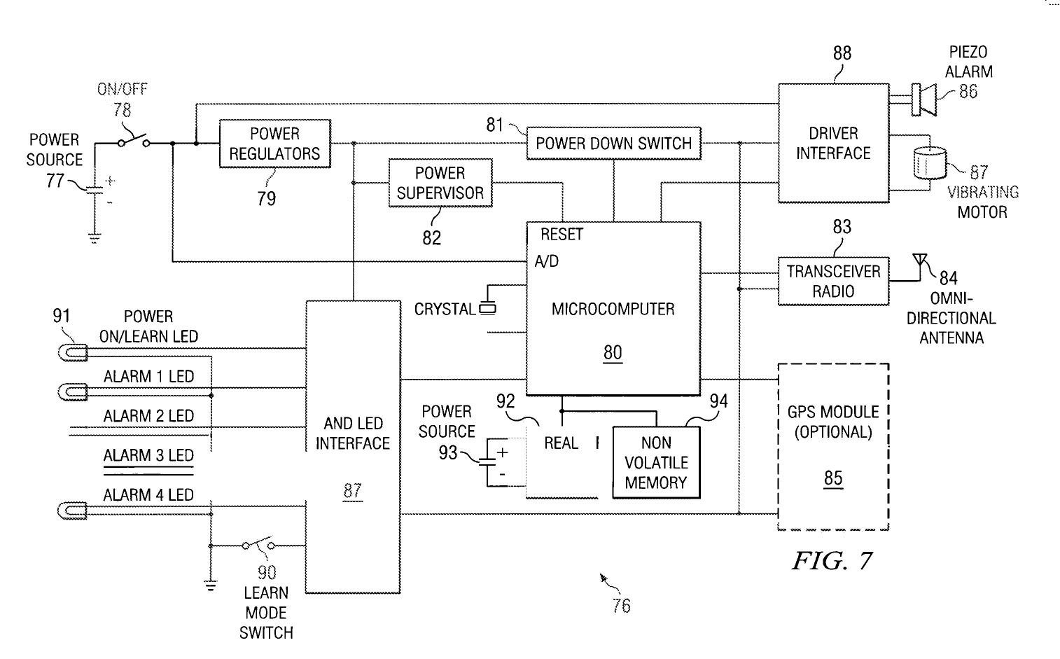

Referring now to FIG. 7, an alternate embodiment of the invention includes a second component 76. The second component 76 is essentially identical to second component 55, however, the keypad and LCD interface 70 of second component 55 is not present in second component 76. In place of the keypad and LCD interface 70, is a switch and LED interface, to be described.

The second component 76 is likewise capable of emitting and receiving a signal, and includes a power system. The power system includes a power source 77 used to power the second component 76 and an on/off switch 78 necessary to turn the power to the second component 76 on and off. Common available batteries can be utilized for the power source 77. Additionally, backup batteries can be utilized in order to facilitate power to the second component 76 in the event of main battery failure. Depending on standby power requirements, the on/off switch may be substituted with a soft switch capable of being activated by keypad depression.

The power system of the second component 76 further includes at least one power regulator 79 for adjusting power in the power source 77 to suitable levels to control a microcomputer 80 and the other electronic components of the second component 76. At least one power down switch 81 of the power system is controlled by the microcomputer 80 to allow electronic components of the second component 76 to be shut down when not in use by the second component 76 for the purpose of conserving power in the power source 77. A power supervisor 82 of the power system will reset the microcomputer 80 in the event power deviates outside of specified limits.

The microcomputer 80 controls all electronic components of the second component 76. The microcomputer 80 monitors the power from the power source 77. For example, when a battery power source is utilized, the microcomputer 80 will monitor the battery voltage. In the event battery power becomes diminished to a specified level, the microcomputer 80 will cause the second component 76 to go into low battery mode. An alarm system or a LED display of the second component 76 can be utilized so as to alert an user that the battery is low, in order to allow the user to change the battery, etc. Likewise, if a first component transmits to the second component 76 that its power source is diminished, the second component 76 can be utilized to alert the user. For example, the alarm system of the second component 76 can be utilized so as to alert the user, or a LED display can be utilized so as to display a flashing low battery indicator corresponding to the first component. Upon noticing the alarm or the flashing low battery indicator, the user will know to change the battery, etc.

The second component 76 also includes a means for emitting and receiving a signal. In the embodiment shown, a transceiver radio 83 utilizing an omni-directional antenna 84 sends an inquiry signal to at least one first component, as further described heretofore. This signal can be sent intermittently or continuously, depending on the specific circumstances. If the first component is within the range of the inquiry signal, the first component emits a response signal. The omni-directional antenna 84 receives the response signal from the first component(s). If the second component 76 receives a response signal via the omni-directional antenna 84 from the first component, no alarm is sounded. However, should the second component 76 fail to receive a timely response signal from any first component, an alarm is sounded. Regulation of the separation distance between the second component 76 and first component that triggers an alarm can be accomplished by regulating the intensity at which the response signal of the first component is emitted as described heretofore. By reducing the intensity of the response signal, the alarm is triggered at a closer distance, and vice versa.

An optional GPS module 85 can also be utilized by the second component 76 as a means to track a first component. The GPS module 85 identifies the longitude and latitude of the second component 76, and the second component 76 receives a signal of a first component transmitting its longitude and latitude to the second component 76. The second component 76 then uses this information to calculate the position of a first component in relation to the second component 76. A LED display is then utilized to display this information to the user. In this manner, the user tracks a first component.

An alarm system including a piezo alarm 86 and a vibrating motor 87 is also included as part of the second component 76. In the embodiment shown, the piezo alarm 86 warns a user when a first component exceeds a specified range from the second component 76 as described heretofore. In addition to the piezo alarm 86, the vibrating motor 87 can also be utilized to warn a user that a first component has exceeded a specified range from the second component 76. The piezo alarm 86 and vibrating motor 87 can also be used to warn the user that the power source 77 is diminished, as discussed heretofore. A driver interface 88 works in conjunction with the microcomputer 80 to control the piezo alarm 86 and vibrating motor 87 accordingly.

A switch and LED interface 89 is included as part of the second component 76. The switch 90 portion of the switch and LED interface 89, is engaged in order to facilitate initial interaction between the second component 76 and a first component. When the switch is engaged, the second component 76 receives and identifies the signal(s) of the first component(s), thereby setting a threshold signal strength, determined by the distance between the second component 76 and the first component(s). Any subsequent greater signal strength of the first component(s) received by the second component 76 indicates that the first component(s) is/are closer to the second component 76, and vice versa. In this manner, the user is able to control the separation distance between the second component 76 and the first component(s) at which the alarm is sounded. The LED display 91 portion of the switch and LED interface 89 implements a series of LED's which are used to alert the user to various events. For example, a specific LED can be coordinated to an individual first component. In the event the corresponding first component exceeds the threshold separation distance from the second component 76, the alarm is triggered and the LED which is coordinated to the first component will flash, indicating to the user which first component triggered the alarm, thereby allowing the user to act accordingly. The LED display 91 also includes a LED which lights up when the power source is activated, indicating to the user that the second component 76 is turned on. As discussed heretofore, the LED display 91 can also be utilized to indicate to the user that the power source 77 is diminished, for example, the power source LED will flash when the power source becomes diminished, indicating to a user that the battery, etc. needs to be changed, etc.

An additional feature of the embodiment shown is a real time clock 92. The real time clock can implement its own power source 93. Common available batteries can be utilized for the power source 93. Additionally, backup batteries can be utilized in order to facilitate power to the real time clock 93 in the event of main battery failure. Alternatively, the real time clock may be powered by the power source 77.

A non volatile memory 94 is included, allowing data or other information to be saved by the second component 76. This saved data or other information can likewise be recalled from the non volatile memory 94 by the user.

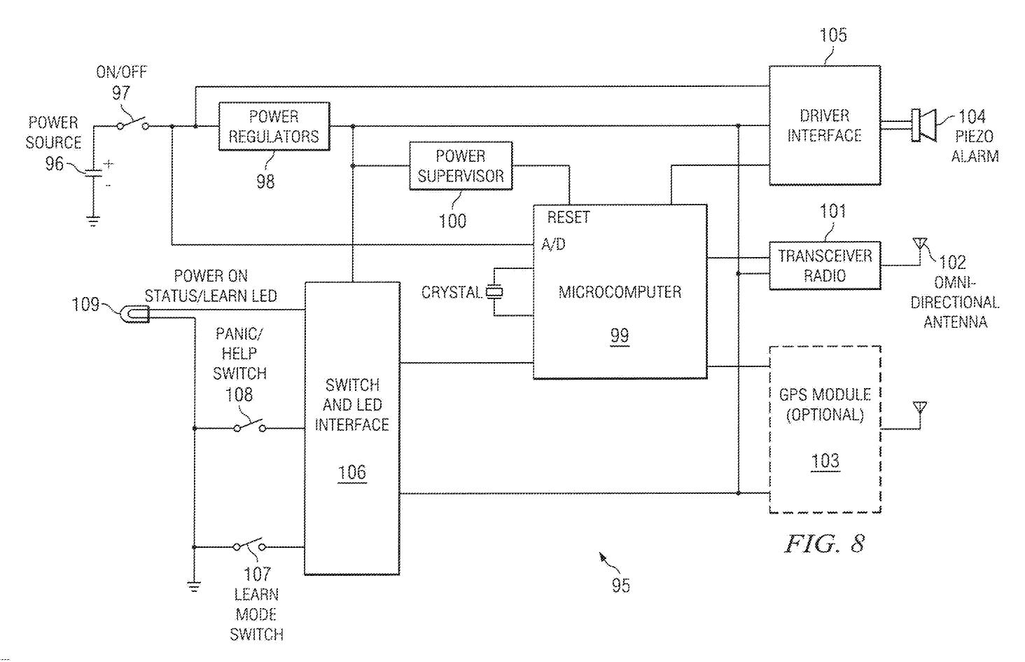

Referring now to FIG. 8, a first component 95 is shown. The first component 95 is capable of emitting and receiving a signal, and includes a power system. The power system includes a power source 96 used to power the first component 95 and an on/off switch 97 necessary to turn the power to the first component 95 on and off. Common available batteries can be utilized for the power source 96. Additionally, backup batteries can be utilized in order to facilitate power to the first component 95 in the event of main battery failure. Depending on standby power requirements, the on/off switch may be substituted with a soft switch capable of being activated by keypad depression.

The power system of the first component 95 further includes at least one power regulator 98 for adjusting power in the power source 96 to suitable levels to control a microcomputer 99 and the other electronic components of the first component 95. A power supervisor 100 of the power system resets the microcomputer 99 in the event power deviates outside of specified limits.

The microcomputer 99 controls all electronic components of the first component 95. The microcomputer 99 monitors the power from the power source 96. For example, when a battery power source is utilized, the microcomputer 99 monitors the battery voltage. In the event battery power becomes diminished to a specified level, the microcomputer 99 causes the first component 95 to go into low battery mode. An alarm system or a LED display of the first component 95 is utilized so as to alert an user that the battery is low, in order to allow the user to change the battery, etc. Likewise, a first component is able to transmit to a second component that its power source is diminished. For example, the alarm system of the first component 95 is utilized so as to so alert the user of the second component, or a LED display of the second component can be utilized so as to display a flashing low battery indicator corresponding to the first component. Upon noticing the alarm or the flashing low battery indicator, the user of either the first component 95 or the second component will know to change the battery, etc.

The first component 95 also includes a means for emitting and receiving a signal. In the embodiment shown, a transceiver radio 101 utilizing an omni-directional antenna 102 sends a response signal to a second component. If the first component is within the range of the inquiry signal from the second component, the omni-directional antenna 102 receives the signal and the first component 95 emits a response signal. Regulation of the separation distance between the second component and first component 95 that triggers an alarm can be accomplished by regulating the intensity at which the response signal of the first component 95 is emitted as described heretofore. By reducing the intensity of the response signal, the alarm is triggered at a closer distance, and vice versa.

An optional GPS module 103 is utilized by the first component 95 as a means to allow a second component to track the first component 95. The GPS module 103 identifies the longitude and latitude of the first component 95, and the first component 95 then allows the first component 95 to transmit its longitude and latitude to a second component. The second component then uses this information to calculate the position of a first component 95 in relation to the second component as described heretofore.

An alarm system including a piezo alarm 104 can also be included as part of the first component 95. In the embodiment shown, the piezo alarm 104 can be sounded when the first component 95 exceeds a specified range from the second component as described heretofore, so as to alert the user of the second component. The piezo alarm 104 can also be sounded by a user of the first component 95, for example, to alert a user of a second component that the user of the first component 95 is in danger, etc. The piezo alarm 104 can also be used to warn the user of the first component 95 that the power source 96 is diminished, as discussed heretofore. A driver interface 105 works in conjunction with the microcomputer 99 to control the piezo alarm 104 accordingly.

A switch and LED interface 106 is included as part of the first component 95. A learn mode switch 107 portion of the switch and LED interface 106, is engaged in order to facilitate initial interaction between the first component 95 and a second component. When the switch is engaged, the first component 95 emits a signal to the second component, thereby setting a threshold signal strength, determined by the distance between the first component 95 and the second component. Any subsequent greater signal strength of the first component 95 received by the second component indicates that the first component 95 is closer to the second component, and vice versa. In this manner, the user is able to control the separation distance between the first component 95 and second component at which the alarm is sounded. A panic/help switch 108 portion of the switch and LED interface 106 can be engaged by a user of the first component 95 to activate the piezo alarm 104, for example, to warn a user of the second component that the user of the first component 95 is in danger, etc. The LED display 109 portion of the switch and LED interface 106 implements a single LED, or, if desired, a series of LED's, which is/can be used to alert the user to various events. For example, in the event the first component 95 exceeds the threshold separation distance from a second component, the alarm will be triggered and the LED will flash, indicating to the user that the threshold separation distance has been exceeded. The LED display 109 also includes a LED which lights up when the power source is activated, indicating to the user that the first component 95 is turned on. As discussed heretofore, the LED display 109 can also be utilized to indicate to the user that the power source 96 is diminished, for example, the power source LED will flash when the power source becomes diminished, indicating to a user that the battery, etc. needs to be changed, etc.

Although preferred embodiments of the invention have been illustrated in the accompanying Drawing and described in the foregoing Detailed Description, it will be understood that the invention is not limited to the embodiments disclosed but is capable of numerous rearrangements, modifications, and substitutions of parts and elements without departing from the spirit of the invention.

1. A separation alert system comprising:
a plurality of first components capable of being secured to separate individuals, each of the first components comprising a means for emitting and receiving a signal;
a second component capable of being secured to an individual, the second component comprising a means for emitting and receiving a signal, a means for generating an alarm, and a means for triggering an alarm; and
means for setting a predetermined distance between each of the plurality of first components and the second component, wherein exceeding the predetermined distance between any of the plurality of first components and the second component thereby actuates the means for triggering an alarm.

2. The separation alert system according to claim 1 wherein the second component emits electronic inquiry signals specific to each of the plurality of first components at predetermined intervals, wherein each of the plurality of first components receives the electronic inquiry signal of the second component specific to the first component receiving the electronic inquiry signal, wherein each of the plurality of first components emits an electronic signal responsive to the electronic inquiry signal of the second component to the second component, wherein the second component receives the electronic signal responsive to the electronic inquiry signal of the second component of each first component, and wherein non-receipt by the second component of any of the electronic signals responsive to the electronic inquiry signal of the second component of any first component actuates the means for triggering an alarm.

3. The separation alert system according to claim 2 wherein the second component emits electronic inquiry signals specific to each of the plurality of first components at periodic intervals.

4. The separation alert system according to claim 2 wherein the second component emits electronic inquiry signals specific to each of the plurality of first components continuously.

5. A separation alert system comprising:
a first component capable of being secured to an animal, the first component comprising a means for emitting and receiving a signal;
a second component capable of being secured to an individual responsible for the animal, the second component comprising a means for emitting and receiving a signal, a means for generating an alarm, and a means for triggering an alarm; and
a means for setting a predetermined distance between the first component and the second component, wherein exceeding the predetermined distance between the first component and the second component thereby actuates the means for triggering an alarm.

6. The separation alert system according to claim 5 wherein the second component emits an electronic inquiry signal at predetermined intervals, wherein the first component receives the electronic inquiry signal, wherein the first component emits an electronic signal responsive to the electronic inquiry signal of the second component to the second component, wherein the second component receives the electronic signal of the first component responsive to the electronic inquiry signal of the second component, and wherein non-receipt by the second component of the electronic signal of the first component responsive to the electronic inquiry signal of the second component actuates the means for triggering an alarm.

7. The separation alert system according to claim 6 wherein the second component emits an electronic inquiry signal at periodic intervals.

8. The separation alert system according to claim 6 wherein the second component emits electronic inquiry signal continuously.
